(19) United States
(12) Patent Application Publication
(10) Pub. No.: US 2021/0273486 A1
(43) Pub. Date: Sep. 2, 2021

(54) SPLICED ALIGNMENT MAGNETIC RING OF WIRELESS CHARGER

(71) Applicant: GD Glory Magnet Technology Co.,Ltd, Dongguan (CN)

(72) Inventor: Yu Tang, Quanzhou (CN)

(73) Assignee: GD Glory Magnet Technology Co.,Ltd

(21) Appl. No.: 17/320,210

(22) Filed: May 13, 2021

(30) Foreign Application Priority Data
Nov. 18, 2020 (CN) 202022671002.7

(51) Int. Cl. H02J 50/00; H02J 50/90

(52) U.S. Cl. CPC H02J 50/005; H02J 50/10; H02J 50/90

(57) ABSTRACT

The present disclosure discloses a spliced alignment magnetic ring of a wireless charger, including a ring base body and at least two magnetic groups. All the magnetic groups are disposed at an interval along a circumferential direction of the ring base body, and all the magnetic groups are arranged on the same side of the ring base body. In the spliced alignment magnetic ring of the wireless charger, the at least two magnetic groups are circumferentially disposed on the ring base body, and a magnetism sensor corresponding to the ring base body is arranged in a wireless charging sensing region on the mobile phone, so that the mobile phone can be automatically and accurately aligned for charging when being placed on the wireless charger.

### TECHNICAL FIELD

The present disclosure relates to the technical field of wireless charging, and particularly relates to a spliced alignment magnetic ring for a wireless charger.

### BACKGROUND

With the advancement of technology, in recent years, more and more mobile phone manufacturers, such as Samsung, Xiaomi, Apple, and Huawei, have introduced mobile phones with wireless charging devices, which has also driven the market for wireless charging devices for mobile phones to a boom. Current wireless charging devices for mobile phones include ordinary desktop wireless charging devices for mobile phones and vehicle-mounted wireless charging devices for mobile phones. In terms of the vehicle-mounted wireless charging devices for mobile phones, magnetic type vehicle-mounted wireless charging brackets for mobile phones are most convenient to operate.

However, since wireless charging for a mobile phone requires that a specific part of the mobile phone gets close to or is in contact with a wireless charger to perform a charging operation, this is realized by accurate positioning of the mobile phone and the wireless charger. However, the current magnetic wireless charger in the market generally does not have this function, and the mobile phone needs to be placed on the wireless charger and adjusted in position constantly to achieve accurate cooperation. In addition, there is an insufficient magnetic force, which causes a phenomenon of unstable attraction of the mobile phone.

### SUMMARY

The present disclosure is directed to provide a spliced alignment magnetic ring of a wireless charger that is capable of realizing accurate positioning of a mobile phone and the wireless charger and has high attraction force, so as to overcome the deficiencies in the prior art.

In order to achieve the above-mentioned purpose, the present disclosure provides the following technical solution: a spliced alignment magnetic ring of a wireless charger, including a ring base body and at least two magnetic groups. All the magnetic groups are disposed at an interval along a circumferential direction of the ring base body, and all the magnetic groups are arranged on the same side of the ring base body; a single magnetic group includes a first magnetic body and a second magnetic body; and the first magnetic body and the second magnetic body magnetically attract each other, and are arranged along a radial direction of the ring base body.

In one of the embodiments, the shape of the first magnetic body corresponds to the shape of the second magnetic body.

In one of the embodiments, both the first magnetic body and the second magnetic body are magnets.

In one of the embodiments, the ring base body is made of an iron metal.

In one of the embodiments, the spliced alignment magnetic ring of the wireless charger further includes a bearing pedestal that is arranged on a side of the ring base body close to the magnetic groups; all the magnetic groups are inset on the bearing pedestal; and the bearing pedestal is provided with accommodating slots corresponding to the magnetic groups.

In one of the embodiments, the bearing pedestal is provided with a gap that is used to dispose an external lead wire.

In one of the embodiments, the ring base body and the bearing pedestal are coaxial.

In one of the embodiments, the bearing pedestal is made of a plastic material.

Compared with the prior art, the present disclosure has the beneficial effects as follows:

In the spliced alignment magnetic ring of the wireless charger of the present disclosure, the at least two magnetic groups are circumferentially disposed on the ring base body, and a magnetism sensor corresponding to the ring base body is arranged in a wireless charging sensing region on the mobile phone, so that the mobile phone can be automatically and accurately aligned for charging when it is placed on the wireless charger. By use of the characteristic that magnetic bodies with different polarities attract each other, since the first magnetic bodies and the second magnetic bodies are disposed, their magnetic attraction contact surfaces achieve a single-side two-pole effect, which enhances the magnetic field intensity of the magnetic groups and improves the attraction force of the wireless charger.

### BRIEF DESCRIPTION OF THE DRAWINGS

FIG. 1 is a schematic structural diagram of a spliced alignment magnetic ring of a wireless charger according to a first embodiment of the present disclosure;

FIG. 2 is a schematic structural exploded diagram of the spliced alignment magnetic ring of the wireless charger shown in FIG. 1;

FIG. 3 is a schematic structural diagram of a spliced alignment magnetic ring of a wireless charger according to a second embodiment of the present disclosure;

FIG. 4 is a schematic structural diagram of a spliced alignment magnetic ring of a wireless charger according to a third embodiment of the present disclosure;

FIG. 5 is a schematic structural exploded diagram of the spliced alignment magnetic ring of the wireless charger shown in FIG. 4;

FIG. 6 is a schematic structural diagram of a spliced alignment magnetic ring of a wireless charger according to a fourth embodiment of the present disclosure; and

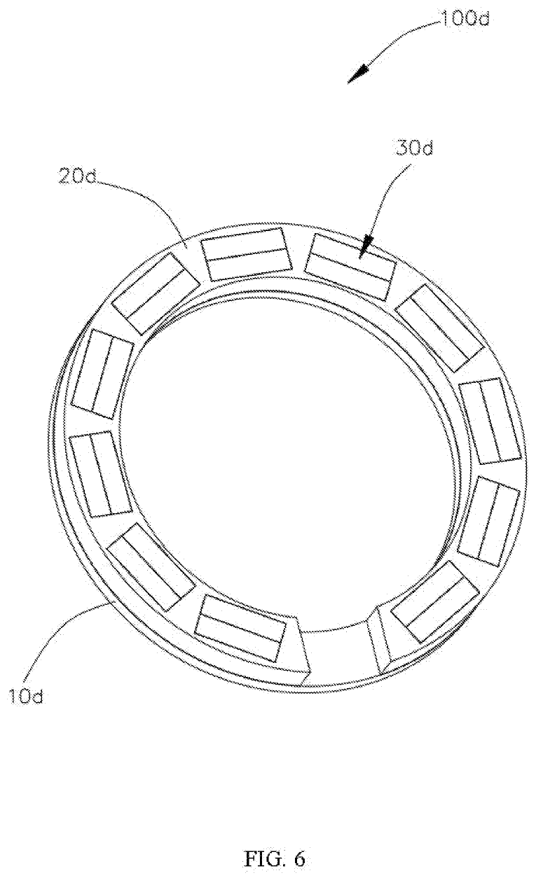

FIG. 7 is a schematic structural exploded diagram of the spliced alignment magnetic ring of the wireless charger shown in FIG. 6.

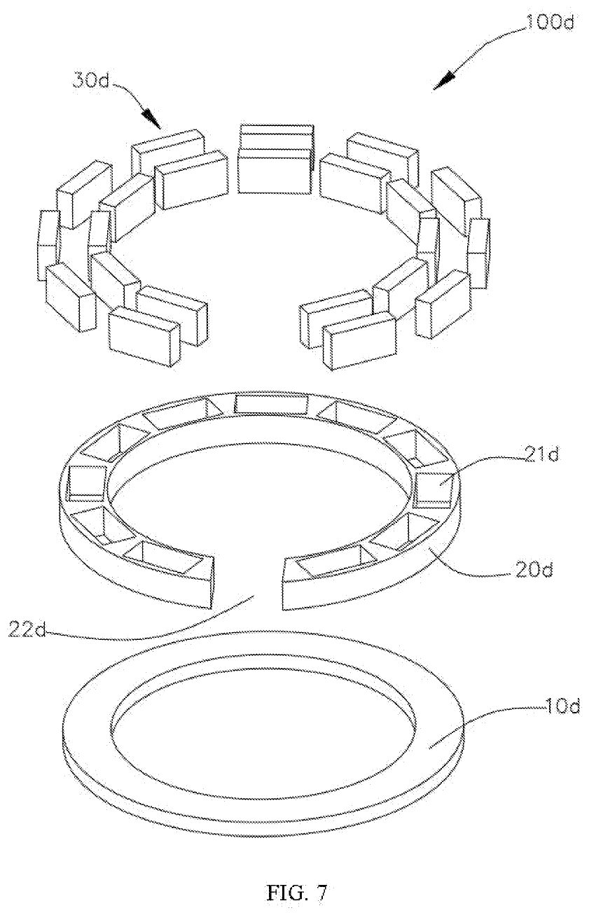

Reference signs in drawings:

100a: spliced alignment magnetic ring of a wireless charger

10a: ring base body; 20a: magnetic group; 21a: first magnetic body; 22a: second magnetic body.

100b: spliced alignment magnetic ring of a wireless charger

10b: ring base body; 20b: magnetic group; 21b: first magnetic body; 22b: second magnetic body.

Numerals in drawings:

100a: spliced alignment magnetic ring of a wireless charger

10a: ring base body; 20a: magnetic group; 21a: first magnetic body; 22a: second magnetic body.

100b: spliced alignment magnetic ring of a wireless charger

10b: ring base body; 20b: magnetic group; 21b: first magnetic body; 22b: second magnetic body.

100c: spliced alignment magnetic ring of a wireless charger

10c: ring base body; 20c: bearing pedestal; 21c: accommodating slot; 22c: gap; 30c: magnetic group.

100d: spliced alignment magnetic ring of a wireless charger

10d: ring base body; 20d: bearing pedestal; 21d: accommodating slot; 22d: gap; 30d: magnetic group.

### DESCRIPTION OF THE EMBODIMENTS

In order to make the foregoing objectives, features and advantages of the present disclosure more obvious and understandable, the specific implementation modes of the present disclosure are described in detail with reference to the accompanying drawings. Many specific details are described in the following descriptions to facilitate full understanding of the present disclosure. However, the present disclosure can be implemented in a variety of other ways different from those described herein, and those skilled in the art can make similar improvements without departing from the connotation of the present disclosure. Therefore, the present disclosure is not limited by specific embodiments disclosed below.

It should be noted that when an element is referred to as being “fixed” to another element, it can be directly on the other element or an intermediate element may also exist. When an element is considered to be “connected” to another element, it can be directly connected to the other element or an intermediate element may be present at the same time. When the number of one element is said to have “multiple”, it can be any number of two or more. The terms “perpendicular”, “horizontal”, “left”, “right” and similar expressions used herein are for illustrative purposes only, and are not meant to be the only implementation modes.

Unless otherwise defined, all technical and scientific terms used herein are the same as meanings of general understandings of those skilled in the art of the present disclosure. The terms used in the description of the present disclosure herein are merely to describe the specific implementation modes, not intended to limit the present disclosure. The term “and/or” used herein includes any and all combinations of one or more related listed items.

The present utility model is described below in detail in combination with all implementation modes shown in the drawings:

### Embodiment I

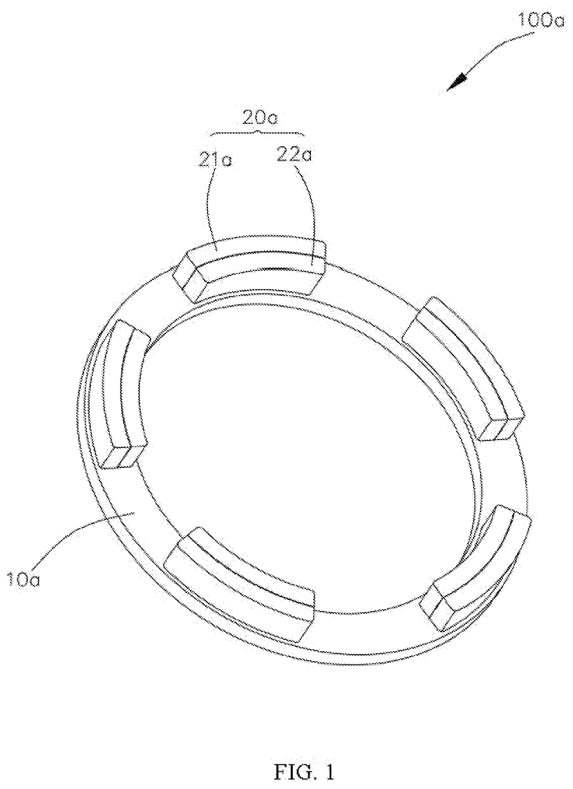

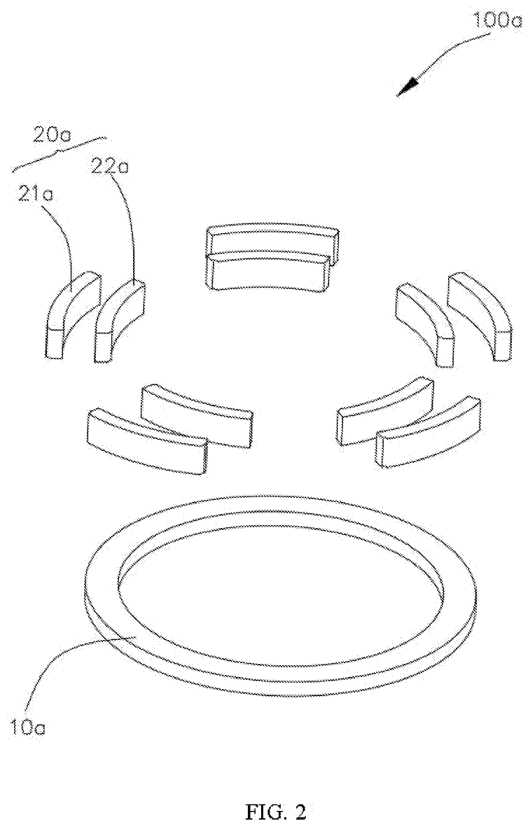

Referring to FIG. 1 to FIG. 2, a spliced alignment magnetic ring of a wireless charger 100a according to one preferred implementation mode of the present disclosure is illustrated, including a ring base body 10a and at least two magnetic groups 20a. All the magnetic groups 20a are disposed at an interval along a circumferential direction of the ring base body. All the magnetic groups 20a are arranged on the same side of the ring base body; a single magnetic group 20a includes a first magnetic body 21a and a second magnetic body 22a; and the first magnetic body 21a and the second magnetic body 22a magnetically attract each other, and are arranged along a radial direction of the ring base body 10a. In the spliced alignment magnetic ring 100a of a wireless charger of the present disclosure, the at least two magnetic groups 20a are circumferentially disposed on the ring base body 10a, and a magnetism sensor corresponding to the ring base body 10a is arranged in a wireless charging sensing region on a mobile phone, so that the mobile phone can be automatically and accurately aligned for charging when it is placed on the wireless charger. By use of the characteristic that magnetic bodies with different polarities attract each other, since the first magnetic bodies 21a and the second magnetic bodies 22a are disposed, their magnetic attraction contact surfaces achieve a single-side two-pole effect, which enhances the magnetic field intensity of the magnetic groups 20a and improves the attraction force of the wireless charger.

As shown in FIG. 1 and FIG. 2, the ring base body 10a is of a ringlike structure; an inner hole of the ring base body 10a is used for placing an induction coil of the wireless charger. In the present embodiment, the ring base body 10a is made of an iron metal. In other embodiments, the ring base body 10a can be made of other materials.

All the magnetic groups 20a are disposed at an interval along the circumferential direction of the ring base body 10a. All the magnetic groups 20a are arranged on the same side of the ring base body 10a. Optionally, there are five magnetic groups 20a. The five magnetic groups 20a are arranged on the same side of the ring base body 10a at an interval to form one magnetic ring; and then, the magnetism sensor corresponding to the ring base body is arranged in the wireless charging sensing region of the mobile phone, so that accurate positioning of the mobile phone and the wireless charger can be realized. The magnetic groups 20a in the present embodiment are sectors. In other embodiments, the magnetic groups 20a may also be rectangular, square and other shapes.

In the present embodiment, each magnetic group 20a includes a first magnetic body 21a and a second magnetic body 22a; the first magnetic body 21a and the second magnetic body 22a magnetically attract each other, and are arranged along a radial direction of the ring base body 10a; a single-side two-pole effect is achieved on contact surfaces of the first magnetic body 21a and the second magnetic body 22a, which enhances the intensity of a magnetic field and improves the attraction force of the wireless charger on the mobile phone. As shown in FIG. 2, the first magnetic body 21a and the second magnetic body 22a are both sectors and coaxial. Optionally, the first magnetic body 21a and the second magnetic body 22a are both magnets. A plurality of first magnetic bodies 21a form an N-pole outer ring, and a plurality of second magnetic bodies 22a form an S-pole inner ring, or a plurality of first magnetic bodies 21a form an S-pole outer ring, and a plurality of second magnetic bodies 22a form an N-pole inner ring, thereby improving the intensity of magnetism of magnetic rings formed by the plurality of magnetic groups 20a.

Optionally, the ring base body 10a is made of the iron metal, so that the magnetic groups 20a can be directly attracted on the ring base body 10a. In other embodiments, the magnetic groups can be fixed on the ring base body 10a with an adhesive if the ring base body 10a is not made of the iron metal.

In the spliced alignment magnetic ring 100a of a wireless charger of the present disclosure, the at least two magnetic groups 20a are circumferentially disposed on the ring base body 10a, and the magnetism sensor corresponding to the ring base body 10a is arranged in a wireless charging sensing region on the mobile phone, so that the mobile phone can be automatically and accurately aligned for charging when it is placed on the wireless charger. By use of the characteristic that magnetic bodies with different polarities attract each other, since the first magnetic bodies 21a and the second magnetic bodies 22a are disposed, their magnetic attraction contact surfaces achieve the single-side two-pole effect, which enhances the magnetic field intensity of the magnetic groups 20a and improves the attraction force of the wireless charger.

### Embodiment II

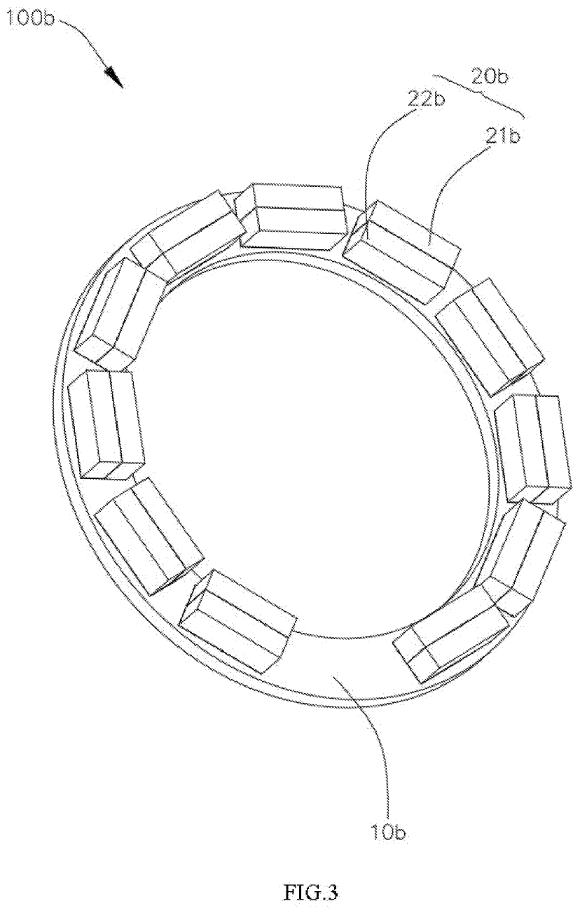

Referring to FIG. 3, a spliced alignment magnetic ring 100b of a wireless charger of the present disclosure is illustrated. The present embodiment is similar to the spliced alignment magnetic ring 100a of a wireless charger of the first embodiment, except a difference that the magnetic groups 20b of the spliced alignment magnetic ring 100b of a wireless charger of the present embodiment is square; all the magnetic groups 20b are arranged at an interval along the circumferential direction of the ring base body 10b. In the present embodiment, there are eleven magnetic groups 20b. The first magnetic bodies 21b and the second magnetic bodies 22b are both square.

### Embodiment III

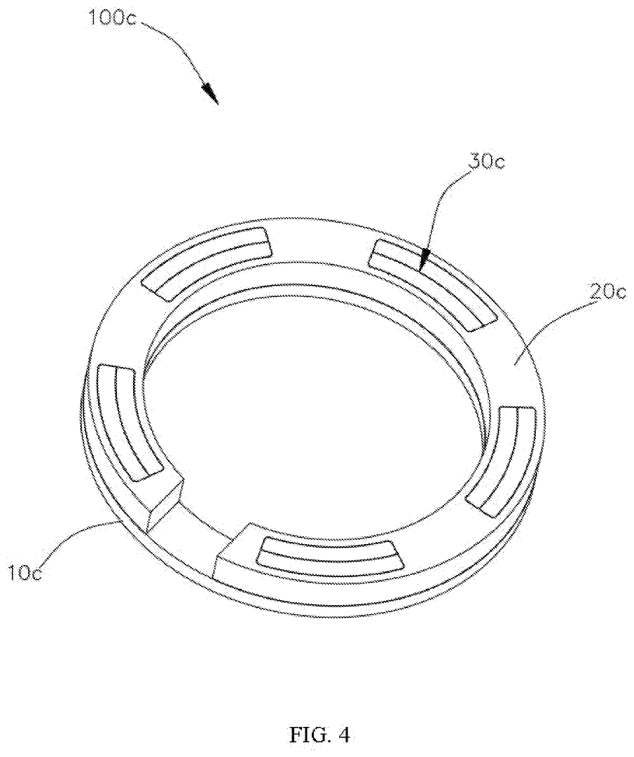

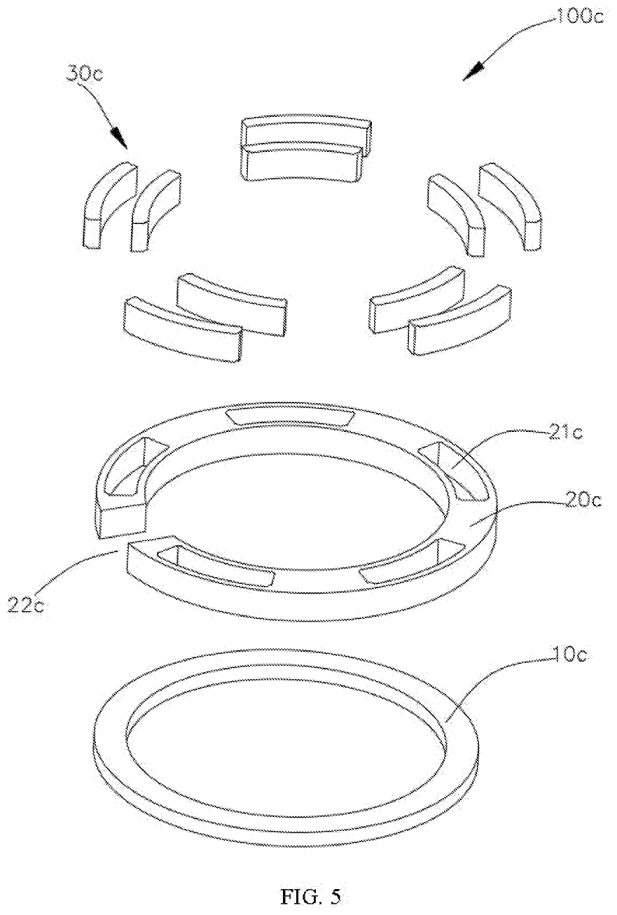

Further referring to FIG. 4 and FIG. 5, a spliced alignment magnetic ring 100c of a wireless charger of the present disclosure is illustrated. The present embodiment is similar to the spliced alignment magnetic ring 100a of a wireless charger of the first embodiment, except a difference that the spliced alignment magnetic ring 100c of a wireless charger of the present embodiment further includes a bearing pedestal 20c.

The bearing pedestal 20c is arranged on a side of the ring base body 10c, and is coaxial with the ring base body 10c; the bearing pedestal 20c is provided with accommodating slots 21c that are sectors. Optionally, there are five accommodating slots 21c. The five accommodating slots 21c are distributed at an interval along a circumferential direction of the bearing pedestal 20c. In other embodiments, there are two or more accommodating slots 21c. Optionally, the bearing pedestal 20c is provided with a gap 22c that is used for disposing an external induction coil lead wire. Optionally, the bearing pedestal 20c is made of a plastic material. The bearing pedestal 20c can achieve a positioning effect, so that the working difficulty in assembling of the spliced alignment magnetic ring 100c of a wireless charger can be lowered, and the working efficiency can be improved.

Magnetic groups 30c are inset in the accommodating slots 21c; the shape of the accommodating slots 21c corresponds to the shape of the magnetic groups 30c; the number of the magnetic groups 30c is in one-to-one correspondence to the number of the accommodating slots 21c. Optionally, there are five magnetic groups 30c and five accommodating slots 21c. The five magnetic groups 30c are respectively inset in the five accommodating slots 21c to form one magnetic ring.

### Embodiment IV

Further referring to FIG. 4 and FIG. 5, a spliced alignment magnetic ring 100d of a wireless charger of the present disclosure is illustrated. The present embodiment is similar to the spliced alignment magnetic ring 100b of a wireless charger of the second embodiment, except a difference that the spliced alignment magnetic ring 100d of a wireless charger of the present embodiment further includes a bearing pedestal 20d.

The bearing pedestal 20d is arranged on a side of the ring base body 10c, and is coaxial with the ring base body 10d; the bearing pedestal 20d is provided with square accommodating slots 21d. Optionally, there are eleven accommodating slots 21d. The eleven accommodating slots 21d are distributed at an interval along a circumferential direction of the bearing pedestal 20d. In other embodiments, there are two or more accommodating slots 21d. Optionally, the bearing pedestal 20d is provided with a gap 22d that is used for placing an external induction coil lead wire. Optionally, the bearing pedestal 20d is made of a plastic material. The bearing pedestal 20d can achieve a positioning effect, so that the working difficulty in assembling of the spliced alignment magnetic ring 100d of a wireless charger can be lowered, and the working efficiency can be improved.

Magnetic groups 30d are inset in the accommodating slots 21d; the shape of the accommodating slots 21d corresponds to the shape of the magnetic groups 30d; the number of the magnetic groups 30d is in one-to-one correspondence to the number of the accommodating slots 21d. Optionally, there are eleven magnetic groups 30d and eleven accommodating slots 21d. The eleven magnetic groups 30d are respectively inset in the eleven accommodating slots 21d to form one magnetic ring.

The technical features of the embodiments described above can be arbitrarily combined. In order to simplify the description, all possible combinations of the technical features in the above embodiments have not been described. However, the combinations of these technical features should be considered as the scope described in this description as long as there is no contradiction in them.

The above-mentioned embodiments only express several implementation modes of the present disclosure, and their descriptions are more specific and detailed, but they cannot be understood as limiting the patent scope of the present disclosure. It should be noted that those of ordinary skill in the art can further make various transformations and improvements without departing from the concept of the present disclosure, and these transformations and improvements all fall within the protection scope of the present disclosure. Therefore, the protection scope of the patent of the present disclosure shall be subject to the appended claims.

What is claimed is:

1. A spliced alignment magnetic ring of a wireless charger, comprising a ring base body and at least two magnetic groups, wherein all the magnetic groups are disposed at an interval along a circumferential direction of the ring base body, and all the magnetic groups are arranged on the same side of the ring base body; a single magnetic group comprises a first magnetic body and a second magnetic body; and the first magnetic body and the second magnetic body magnetically attract each other, and are arranged along a radial direction of the ring base body.

2. The spliced alignment magnetic ring of the wireless charger according to claim 1, wherein the shape of the first magnetic body corresponds to the shape of the second magnetic body.

3. The spliced alignment magnetic ring of the wireless charger according to claim 1, wherein both the first magnetic body and the second magnetic body are magnets.

4. The spliced alignment magnetic ring of the wireless charger according to claim 1, wherein the ring base body is made of an iron metal.

5. The spliced alignment magnetic ring of the wireless charger according to claim 1, further comprising a bearing pedestal that is arranged on a side of the ring base body close to the magnetic groups, wherein all the magnetic groups are inset on the bearing pedestal; and the bearing pedestal is provided with accommodating slots corresponding to the magnetic groups.

6. The spliced alignment magnetic ring of the wireless charger according to claim 5, wherein the bearing pedestal is provided with a gap that is used to dispose an external lead wire.

7. The spliced alignment magnetic ring of the wireless charger according to claim 5, wherein the ring base body and the bearing pedestal are coaxial.

8. The spliced alignment magnetic ring of the wireless charger according to claim 5, wherein the bearing pedestal is made of a plastic material.
